(19) United States
(12) Patent Application Publication
(10) Pub. No.: US 2023/0065069 A1
(43) Pub. Date: Mar. 2, 2023

(54) DETECTION AND BLOCKING OF MESSAGES BASED ON URL BRAND PHISHING OR SMISHING

(71) Applicant: RealNetworks, Inc., Seattle, WA (US)

(72) Inventors: Mirko Coric, Zagreb (HR); Stefano Melucci, New York, NY (US); Michael J. Bordash, Newtown, CT (US)

(21) Appl. No.: 17/458,008

(22) Filed: Aug. 26, 2021

(51) Int. Cl. H04L 29/06; H04L 12/58; G06F 40/253

(52) U.S. Cl. CPC H04L 63/1483; H04L 51/12; G06F 40/253

(57) ABSTRACT

Systems and methods for processing messages to determine if the message is potentially fraudulent. The system determines if a word in the message matches a known fraudulent word or a known safe word and labels the message as potentially fraudulent in response the word matching a known fraudulent word. Otherwise, the system determines a probability that the word is potentially fraudulent based on message context. In response to determining that the probability exceeds a first threshold, the system determines distances for each pair of word/known safe words (e.g., known brands). The system labels the message as potentially fraudulent in response to the distance of a pair exceeding a second threshold. If the message is labeled as potentially fraudulent it is discarded, otherwise it is forwarded towards the destination.

### TECHNICAL FIELD

The following disclosure relates generally to techniques for processing messages, and in particular for identification and blocking of messages based on brand information.

### BACKGROUND

### Description of the Related Art

The quantity of messages being sent within and between messaging platforms has risen steadily in the last several years, typically corresponding to a rise in a quantity of mobile device and other subscriber users, as well as a rise in the use of alternative types of such messages. For example, in addition to traditional user-to-user or peer-to-peer (“P2P”) textual (e.g., SMS) or multimedia (e.g., MMS) messages, increasing quantities of application-to-person (“A2P”), and machine-to-machine (“M2M”) messages are being transmitted within and between such messaging platforms. Moreover, despite numerous historical and ongoing attempts to identify and curtail non-authorized solicitations, unauthorized commercial or “spam” messages also continue to proliferate.

When messages are transmitted from a sender to one or more recipients, those messages are often scanned to detect spam or improper messages. Those scanning techniques, however, can be often avoided, fooled, or be rendered ineffective. For example, relying on users to identify and forward information regarding spam messages can suffer from low report rates and delays. Legitimate users may also be impacted if fake spam reports are provided. Relying on volumetrics, which block users that send messages in exceptionally high volumes, can suffer from high false alarm rates. Legitimate customers may send significantly high volumes for legitimate reasons, such as for promotions or sending information to subscribers. Volumetric systems can inadvertently block these legitimate senders. Moreover, spammers can distribute their volume across many different senders, trying to circumvent volumetric thresholds (a technique known as snowshoeing). Utilization of common spam keywords or phrases can be avoided by adjusting the message content. Similarly, spammers can change their sending information to avoid systems that block particular senders. It is with respect to these and other considerations that the present disclosure has been prepared.

### BRIEF SUMMARY

Embodiments described herein are generally directed to the processing of intra- and inter-messaging platform communications. Messages originating from one sender for distribution to a recipient, where the sender and recipient may be on a same or separate messaging platform, are a processed to determine if the message is fraudulent or potentially fraudulent, such as spam, ham, phishing, or smishing, or is not fraudulent.

A pre-check module or circuitry determines if the word matches a known fraudulent word or a known safe word and labels the message as potentially fraudulent in response to determining that the word matches a known fraudulent word. A candidate creation module or circuitry determines a probability that the word is potentially fraudulent based on context of the word in the message in response to determining that the word does not match a known fraudulent word or a known safe word and labels the message as a potentially fraudulent in response to determining that the probability exceeds a first threshold. A distance calculation module or circuitry determines grammatical distance values between the word and each known safe word from a list of known safe words for each word/known safe word pair in response to determining that the probability does not exceed the first threshold. A spam decision module or circuitry labels the message as potentially fraudulent in response to the grammatical distance value of a word/known safe word pair exceeding a second threshold, such that the message is discarded in response to labeling the message as potentially fraudulent or forwarded towards the destination in response to not labeling the message as potentially fraudulent.

Overall, embodiments described herein improve and enhance the likelihood of detecting a fraudulent message, while reducing the computing resources necessary to determine if a message is fraudulent or not.

### BRIEF DESCRIPTION OF THE SEVERAL VIEWS OF THE DRAWINGS

Non-limiting and non-exhaustive embodiments are described with reference to the following drawings. In the drawings and specification, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment that includes a message processing system in accordance with techniques described herein.

FIG. 2 illustrates a system diagram of a message transport platform within a message processing system in accordance with techniques described herein.

FIG. 3 illustrates a logical flow diagram showing an overview process for detecting if a message is possibly fraudulent in accordance with embodiments described herein.

FIGS. 4A and 4B illustrate a logical flow diagram showing one embodiment of a more detailed process for detecting if a message is possibly fraudulent in accordance with embodiments described herein.

FIG. 5 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The following is a brief introduction to messaging platform communications. In general, messages can be peer-to-peer (“P2P”)(e.g., from a first personal communication device to a second personal communication device), application-to-person (“A2P”)(e.g., from an application server to a personal communication device that has a corresponding application installed thereon), or machine-to-machine (“M2M”)(e.g., from one non-personal device to another non-personal device, such as with Internet-of-Things devices). Messages sent from a first device associated with a first messaging platform to a second device associated with a distinct second messaging platform (e.g., a textual message sent from a Verizon subscriber to a T-Mobile subscriber or a textual message sent from a social-media-application server to a Verizon subscriber) may or may not be delivered by either or both of those two messaging platforms alone. For example, some P2P messages are carrier to carrier. However, some over-the-top service providers can also send and receive messages. In some scenarios, over-the-top service providers can connect and transmit messages with carriers either directly or through an interconnect vendor. In A2P and M2M messages, additional entities are often utilized in sending and receiving messages, which may include one or more carriers, over-the-top service providers, aggregators, brand or enterprise computing devices, etc.

In order to improve the routing of messages between messaging platforms, messages are often provided from the originating messaging platform to a message transport platform provider for forwarding to the destination messaging platform, which in turn handles delivery of the messages to the intended destination device within that destination messaging platform. In certain scenarios, the message transport platform may provide additional functionality, such as determining the correct destination messaging platform, appropriately decoding the message as provided by the originating messaging platform, and appropriately encoding the message for provision to the destination messaging platform.

Embodiments described herein can be implemented by one or more entity computing devices, systems, networks, or platforms that are utilizes to handle or forward messages between a sender device and a recipient device, including: carriers, interconnect vendors, over-the-top service providers, aggregators, or the like. The present disclosure is directed to techniques for providing additional functionality related to processing intra- and inter-platform messages, such as by analyzing messages to detect potentially fraudulent messages from safe or legitimate messages. In general, a potentially fraudulent is a message that is unintended or unwanted by the recipient, intended to extort or obtain information from the recipient, designed to harm or impact the recipients computing system, threatening or considered to be threatening to people or computing systems, etc. Such messages may attempt to harm the recipient, harass the recipient, or gain the trust or confidence of the recipient for nefarious purposes.

As used herein, the terms “messaging platform” or “message processing provider” or “message processing entity” as used herein may be used interchangeably and refer to an entity or computing system that facilitates the reception, forwarding, processing, or dissemination of messages between an originating device and a destination device. Such messaging platforms may include carrier networks or non-carrier networks (e.g., service providers, aggregators, company or brand computing devices, or other entities). In some embodiments, a messaging platform may be a private network associated with a carrier, such as may be used by that carrier to provide its telephony, data transmission, and messaging services (e.g., in P2P communications). In other embodiments, the messaging platform may be a computing device or system that can generate or send messages to other computing devices (e.g., in M2M communications or in A2P communications). It will be appreciated that depending on the identities and affiliations of a message originating device and the intended message destination device associated with a given intra- or inter-platform communication, messaging platforms may operate as an originating messaging platform, a destination messaging platform, or an intermediate forwarding messaging platform, or a combination thereof, at any time. Messaging platforms can therefore include one or more private networks, one or more public networks, or some combination thereof. In various embodiments, the originating or destination device may be “mobile subscribers,” such as in the case where a messaging transport platform (e.g., a customer of the Message Processing System) is itself a Mobile Network Operator and the message analyzed by the Message Processing System is then delivered directly to its mobile subscriber. One non-limiting example may be where an entity (e.g., Google) has a direct connection to submit messages to a carrier (e.g., Verizon), where the carrier is using the Message Processing system for its capabilities and then delivering the message to one of its subscribers.

As used herein, the term “carrier” refers to a provider of telecommunication services (e.g., telephony, data transmission, and messaging services) to its client subscribers. Non-limiting examples of such carriers operating within the United States may include Verizon Wireless, provided mainly by Verizon Communications Inc. of Basking Ridge, NJ; AT&T Mobility, provided by AT&T Inc. of DeKalb County, GA.; Sprint, provided by Sprint Nextel Corporation of Overland Park, KS.; T-Mobile, provided by Deutsche Telecom AG of Bonn, Germany; Facebook and/or Facebook messenger, provided by Facebook Inc. of Menlo Park, Ca; Twitter, provided by Twitter Inc. of San Francisco, Calif.; WhatsApp, provided by WhatsApp Inc. of Menlo Park, Calif.; Google+, provided by Google Inc. of Mountain View, Calif.; SnapChat, provided by Snap Inc. of Venice, Calif., and the like.

The term “message” as used herein refers to textual, multimedia, or other communications sent by a sender to a recipient, and may be used interchangeably with respect to “communication” herein unless the context clearly dictates otherwise. The sender or recipient of a message may be a person, a machine, or an application, and may be referred to as the originating device and the destination device, respectively. Thus, messages may be communications sent by one person to another person, communications sent by a person to a machine or application, communications sent by a machine or application to a person, or a communications sent by a machine or application to another machine or application.

Non-limiting examples of transmission types for such communications include SMS (Short Message Service), MMS (Multimedia Messaging Service), GPRS (General Packet Radio Services), SS7 messages, SMPP (Short Message Peer-to-Peer) social media, Internet communications, firewall messaging traffic, RCS (Rich Communication Services), or other messages. The term “person” as used herein refers to an individual human, a group, an organization, or other entity. In some example embodiments, messages may include messaging traffic from firewalls, such that the Message Processing System described herein can be used to analyze this traffic (especially traffic blocked by Firewalls) to determine if blocked content could be authorized (where acceptable) and converted to monetizable traffic. As another example embodiment, messages may include RCS messages, where the Message Processing System described herein can be utilized to support analysis of message characteristics and content, such as to analyze chatbot-like automated, contextual responses and messages (e.g., by employing machine learning to train the Message Processing System with known chatbot responses).

The term “customer environment” or “customer platform” or “customer computing device” as used herein may be used interchangeably and refer to an entity associated with the reception, transmission, or dissemination of messages between an originating device associated with a originating messaging platform and a destination device associated with a destination messaging platform, where the customer utilizes a Message Processing System, as described herein, to classify and manage message transmissions and associated transmission information. Accordingly, the customer may be a carrier, the originating messaging platform, the destination messaging platform, an aggregator, over-the-top service providers, brand, enterprise, the originating device of a message, or other messaging platform or entity that is utilizing the Message Processing System described herein. Such entities may be referred to as “users,” “customers,” or “clients” of the Message Processing System or the messaging transport platform, as described herein.

The term “user” as used herein refers to a person, individual, group entity, organization, or messaging platform interacting with the Message Processing System that is used or implemented by a customer environment, including past, future or current users of such a system. Reference herein to a “user” without further designation may therefore include a single person, a group of affiliated persons, or other entity and may include the computing device used by such a user. In various embodiments, the user may also be referred to as a customer.

The term “message device identifier” as used herein refers to a unique identifier of a message originating device or a message destination device. The message device identifier may be a mobile device number (MDN), an Internet Protocol (IP) address, a media access control (MAC) address, or some other unique identifier. Thus, the message device identifier may be a sequence of digits, characters, or symbols assigned to a particular device or entity for data transmission via messaging platforms or other communications network(s).

A “P2P” or “peer-to-peer” message as used herein describes communications sent from a person to one or more other persons, and may in certain scenarios be contrasted with an “application-to-person” or “A2P” message sent to one or more persons and initiated by any automated or semi-automated facility, such as a hardware- or software-implemented system, component, or device. Typical but non-limiting examples of P2P messages include messages between individual persons of messaging platforms (e.g., “Hi Mom”); authorized promotional offers; non-authorized commercial solicitation (i.e., “spam”); etc. Typical but non-limiting examples of A2P messages include social media application messages, video game or other application messages, promotional offers; spam; device updates; alerts and notifications; two-factor authentication; etc. In addition, “machine-to-machine” or “M2M” messages as used herein include messages sent between automated facilities (such as “IoT” or “Internet of Things” communications), and may in certain scenarios and embodiments be used interchangeably to describe “application-to-application” or “A2A” communications. Typical but non-limiting examples of M2M messages include device updates, alerts and notifications, and certain instances of two-factor authentication. It will be appreciated from the examples above that P2P, A2P, and M2M message types are not mutually exclusive; various categories of communications may be appropriately associated with multiple such message types.

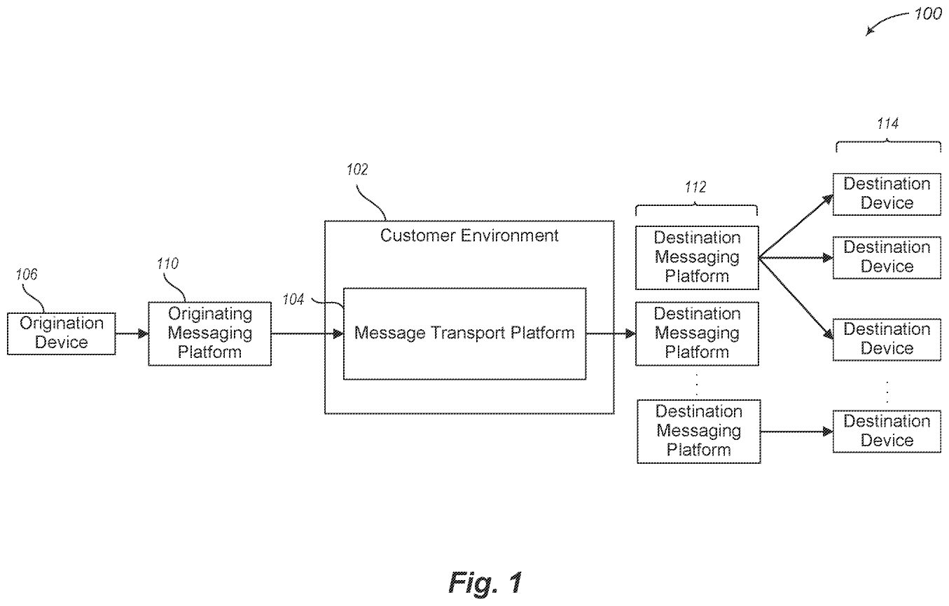

FIG. 1 is a schematic diagram of a networked environment that includes a message processing system in accordance with techniques described herein. Environment 100 includes an origination device 106, an originating messaging platform 110, a customer environment 102, one or more destination messaging platforms 112, and one or more destination devices 114.

The customer environment 102 may be part of an originating messaging platform 110, a destination messaging platform 112, an aggregator, an over-the-top service provider, or other entity associated with the transmission of a message from the origination device 106 on the originating messaging platform 110 to one or more destination devices 114 on one or more destination messaging platforms 112.

The customer environment 102 includes a message transport platform 104. The message transport platform 104 facilitates the receipt, analysis, and transmission of messages. The customer environment 102 receives an incoming message from the originating messaging platform 110 and provides it to the message transport platform 104. The message transport platform 104 performs embodiments described herein to label the message as potentially fraudulent or as a safe or legitimate message. If the message is identified as potentially fraudulent, then the message is blocked from further processing and transmission towards the destination device 114. If, however, the message is labeled as safe, then the message transport platform 104 processes and forwards the message to the appropriate destination messaging platform 112 for dissemination to the appropriate destination device 114.

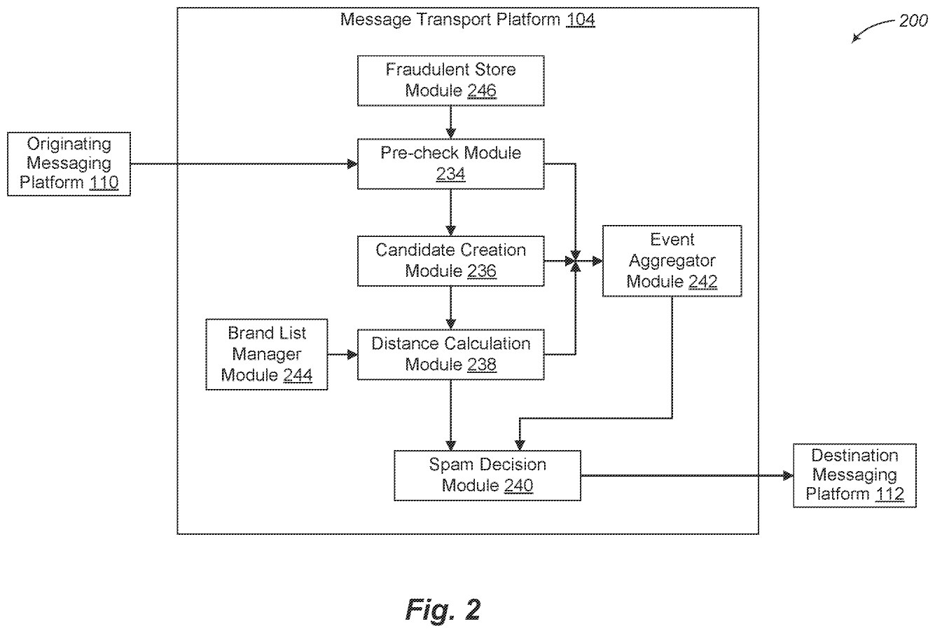

FIG. 2 illustrates a system diagram of a message transport platform within a message processing system in accordance with techniques described herein. The environment 200 illustrated in FIG. 2 includes a message transport platform 104 that receives messages from an originating messaging platform 110 and transmits safe messages to a destination messaging platform 112.

In general, the message transport platform 104 includes a pre-check module 234, a candidate creation module 236, a distance calculation module 238, a spam decision module 240, an event aggregator module 242, a brand list manager module 244, and a fraudulent store module 246. One or more of these modules may be implemented as software, hardware, or a combination thereof. For example, in one embodiment, the functionality of each of these modules may be implemented using circuitry. In another embodiment, the functionality of each of these modules may be implemented by one or more processors executing software computer instructions. In some embodiments, the fraudulent store module 246 may collect false positives generated by the system and added into a special cache, which can whitelist those words (i.e., prevent the system from blocking them).

The pre-check module 234 receives a message from the originating messaging platform 110. In general, the pre-check module 234 is a filter that prevents the complete processing of words that are known to be fraudulent or known to be safe. The pre-check module 234 applies one or more pre-check rules against each word in the message. In various embodiments, the pre-check rules are employed to determine if a word matches a known safe word or if a word matches a known fraudulent word.

In various embodiments, the pre-check module 234 obtains or accesses a list of known safe words and a list of fraudulent words that are stored and maintained by the fraudulent store module 245. The fraudulent store module 245 may operate as a cache for the pre-check module 234 for processing the incoming message in accordance with the pre-check rules. In some embodiments, these lists are generated by one or more users or administrators. In other embodiments, these lists are generated by employing embodiments described herein to identify safe or fraudulent words. In yet other embodiments, a user or administrator may generate, modify, or update the lists and embodiments described herein may be employed to further modify or update the lists.

In various embodiments, the pre-check rules are employed to determine if an entire word or substring is an exact match to a known safe word or a known fraudulent word. For example, the pre-check rules may be employed to identify everyday words, such as “a,” “the,” “text,” etc., and remove those words from further processing. Likewise, the pre-check rules may be employed to identify matches with known safe words. For example, if a message includes the brand name “XYZ_Shoes,” and “XYZ_Shoes” is a known safe word, then that word may be labeled as safe and removed from further processing. As yet another example, if a message includes the word “XYZ_SHOOOES,” and “XYZ_SHOOOES” is a known fraudulent word, then that message may be labeled as potentially fraudulent without further processing.

In some embodiments, pre-check rules may compare full words. In other embodiments, a small number of random characters within the message may be compared to a predefined set of characters. In yet other embodiments, the pre-check rules are employed to determine if a word is a valid word in a known language. These example rules are for illustrative purposes and other types of rules may be employed to reduce the number of words that need additional processing described herein.

If the pre-check module 234 determines that a word or string within the message violates a pre-check rule and determines that the message is potentially fraudulent, such as a word matching a known fraudulent word, then the pre-check module 234 may label the message as potentially fraudulent and block the message from further processing and from transmission to the destination messaging platform 112. Conversely, if the pre-check module 234 determines that all words or strings within the message conform to all pre-check rules and determines that the message is not potentially fraudulent, such as if all words match known safe words, then the pre-check module 234 may forward the message to the destination messaging platform 112 without further processing by the candidate creation module 236, the distance calculation module 238, and the spam decision module 240. Moreover, if the pre-check module 234 determines that one or more words or strings within the message violates a pre-check rule and cannot determine if all the words are safe words or if a word matches a fraudulent word such that the message itself is not automatically labeled as potentially fraudulent, then the pre-check module 234 may forward the message and those additional words to the candidate creation module 236 for further processing.

The candidate creation module 236 receives these additional words within the message from the pre-check module 234. Again, these additional words or strings are previously determined to not match a known safe word or a known fraudulent word. In some embodiments, the candidate creation module 236 may analyze words or strings only. In other embodiments, the candidate creation module 236 may analyze surrounding words using both characters of the input word and context of the message.

The candidate creation module 236 employs one or more classification mechanisms on the received words to output an indication or probability that the words are potentially fraudulent. The candidate creation module 236 may include or employ one or more machine learning models, artificial intelligent mechanisms, or other rules that determine if an input word is a candidate for being potentially fraudulent. The machine learning mechanism or architecture can be any machine learning model that works with characters and context. Examples of such mechanisms may include character-based convolutional neural networks (CNN), long-short term memory (LSTM), or based on Transformer architecture.

In various embodiments, the machine learning mechanism employed by the candidate creation module 236 combines both rule-based features and text or stacked machine learning models can be used for determining the final label or probability. If the candidate creation module 236 determines a probability that a word is potentially fraudulent, then a threshold value can be utilized to label the word as potentially fraudulent or not. This threshold may be set by a user or an administrator to achieve balance between a number of false positives and false negatives of the system. Moreover, various different types of statistical machine learning methods, such as gradient boosting, may be used to combine text features and rules.

If a word is labeled or has a probability indicating that the word is potentially fraudulent, then those candidate words are provided to the distance calculation module 238. If a word is labeled or has a probability indicating that the word is not potentially fraudulent, then those words are not processed further by the distance calculation module 238 and the spam decision module 240. If, after the candidate creation module 236 processes a message, all words in the message are determined to be a safe word by the pre-check module or labeled as a non-potential fraudulent word by the candidate creation module 236, then that message may be labeled as safe and forwarded to the destination messaging platform 112 without further processing by the distance calculation module 238 and the spam decision module 240.

The distance calculation module 238 calculates a grammatical distance value between the candidate words received from the candidate creation module 236 and known safe words stored and maintained by the brand list manager module 244. Accordingly, a grammatical distance value is created for each word/known safe word pair generated from each combination of candidate words and known safe words.

The brand list manager module 244 generates a dynamic list of known safe words or receives a static list of known safe words from a user or administrator. In some embodiments, the known safe words maintained by the brand list manager module 244 are the same as the known safe words used by the pre-check module 234. In other embodiments, the known safe words analyzed by the brand list manager module 244 are different from the known safe words used by the pre-check module 234. The known safe words analyzed by the distance calculation module 238 may be known brands, slogans, company or product names, company or product nicknames, trademarks, or other known company, product, or service term. In various embodiments, automated or manual feedback may be incorporated into the brand list manager module 244 to adjust the list of known safe words.

The distance calculation module 238 can utilize any commonly used distance measure for two string values, such as Levenshtein or Damerau-Levenshtein. In some embodiments, the mechanism used to calculate the grammatical distance between a candidate word and a known safe word may be modified to distinguish between intentional and unintentional misspellings. For example, substituting a “l” (number one) for an “i” (lowercase letter “I”) or an “l” (lowercase letter “L”) may result in an increased distance value compared to substituting an “o” (lowercase letter “O”) or a “k” (lowercase letter “K”) for an “i” (lowercase letter “I”) or an “l” (lowercase letter “L”). The substitution of a “l” for an “i” or an “l” may indicate an intentional misspelling due to the keyboard distance between these characters. Conversely, the substitution of an “o” or a “k” for an “i” or an “l” may indicate an unintentional keystroke due to the keys being adjacent or in near proximity to one another on the keyboard.

Accordingly, some character substitutions may be penalized differently from other character substitutions. In various embodiments, these types of penalties in the distance calculation may be of two types: intentional and unintentional. Intentional operations are penalized with smaller thresholds compared to unintentional. Intentional operations are those performed by a scammer to disguise the message from known filters, while also making the message readable to a human. Unintentional operations are those that can stem from missed keystrokes, errors in OCR operations, or other artifacts or errors caused by a human.

In various embodiments, the distance calculation module 238 may maintain or utilize a list of intentional operations, which may be developed from historical data and stored in a dictionary of intentional operations. In yet other embodiments, continuous probability distribution for each character substitution can be developed, utilized, and stored in the corresponding dictionary. In some embodiments, the distance calculation module 238, the brand list manager module 244, or some other module, or a combination thereof may be utilized to generate and maintain the penalties for different character substitutions.

The distance calculation module 238 provides the grammatical distance values for each candidate word/known safe word pair to the spam decision module 240.

The spam decision module 240 determines whether a word is potentially fraudulent based on the grammatical distance values between word and the known safe words. In various embodiments, the spam decision module 240 may compare the grammatical distance values with one or a plurality of thresholds. In one embodiment, if a grammatical distance value exceeds a fraudulent threshold, then that word, and the message itself, is labeled as potentially fraudulent and the message is blocked from further transmission.

In other embodiments, two thresholds may be employed. If a grammatical distance value exceeds a first threshold, then that word, and the message itself, is labeled as potentially fraudulent and the message is blocked from further transmission. If the grammatical distance value does not exceed the first threshold, but exceeds a second threshold, then additional fraudulent metrics are employed to determine if the word is potentially fraudulent. For example, the additional metrics may analyze different features related to message, such as volume of messages send from a sender (e.g., number of messages per day), volatility of sent messages, number of distinct senders, or other message features. Weightings for one or more features can be utilized and modified based on user input or by employing one or more machine learning mechanisms. User feedback may also be used to increase the performance of the system in real time. If a grammatical distance value does not exceed the second threshold, then that word is labeled as a safe word. These thresholds may be set by a user or an administrator. Moreover, these thresholds can be manually or automatically overridden based on changes in message overtime due to how criminals evolve their SMiShing attacks.

In various embodiments, the spam decision module 240 may use a combination of the grammatical distance values and an aggregation of events associated with that word. The event aggregator module 242 may collect and store results from the pre-check module 234, the candidate creation module 236, and the distance calculation module 238. These results may be collected over time across the processing of multiple messages. The event aggregator module 242 then stores the aggregated results on a per word basis, which may include a total aggregated number of events. An event may be identified as a word being labeled by the pre-check module 234 as a word needing additional processing (e.g., it does not match a known safe word or a known fraudulent word), a word being identified as a candidate word as potentially fraudulent by the candidate creation module 236, or a word having a grammatical distance value with a known safe word exceeding a threshold value.

The spam decision module 240 can obtain the aggregated results for a word from the event aggregator module 242. The spam decision module 240 can then combine the received number of detected events for a word and an absolute grammatical distance value for a word/known safe word pair to generate a combined value. This combined value is then compared to the thresholds described above.

If, after the spam decision module 240 processes a message, all words in the message are determined to be a safe word by the pre-check module 234, or labeled as a non-potentially fraudulent word by the candidate creation module 236, or identified as safe by the spam decision module 240, then that message may be labeled as safe and forwarded to the destination messaging platform 112.

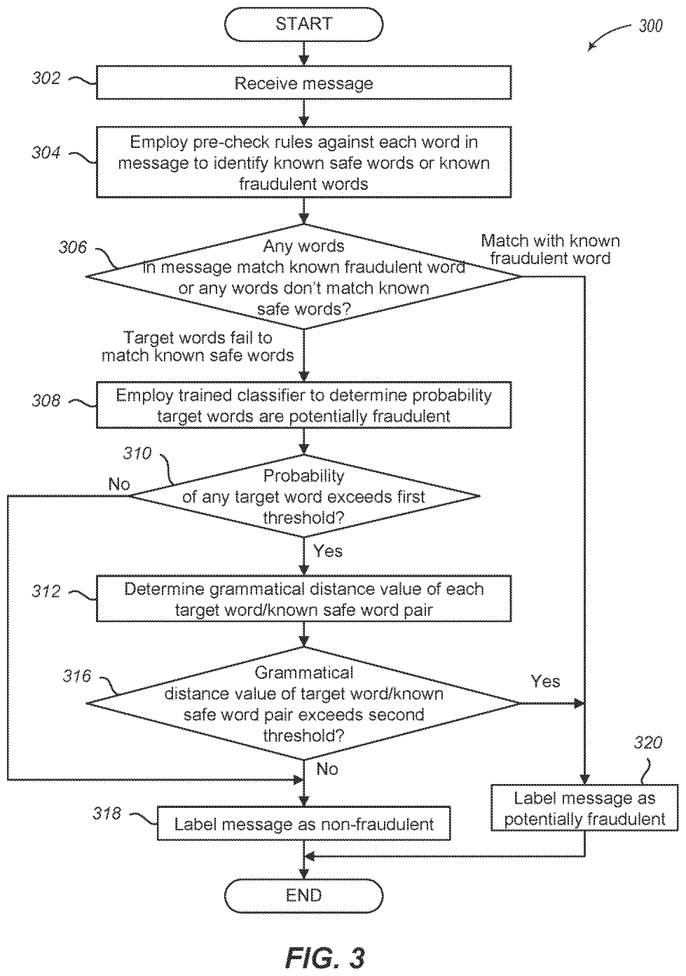

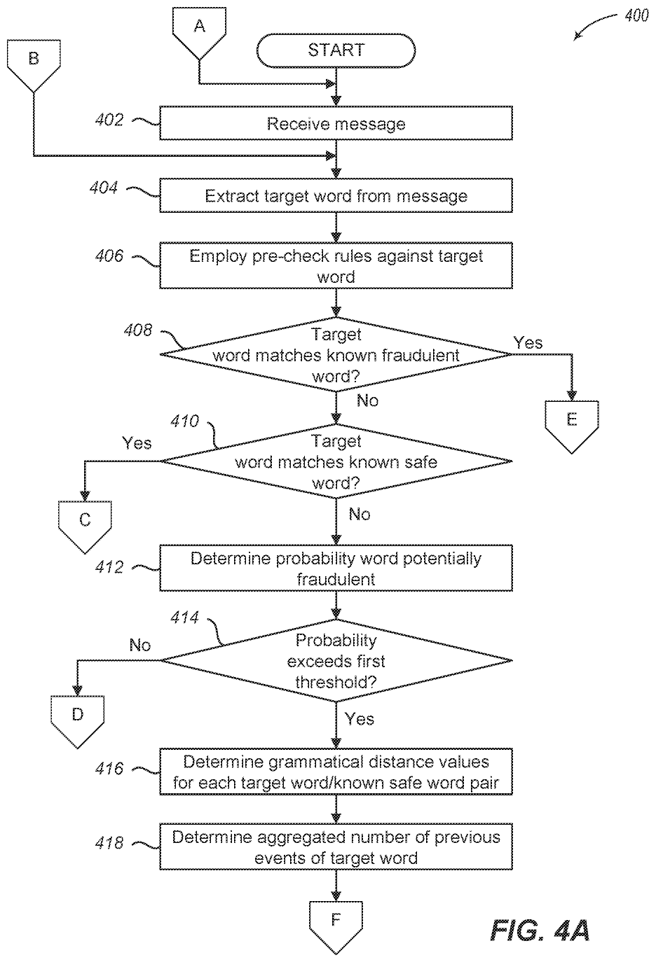

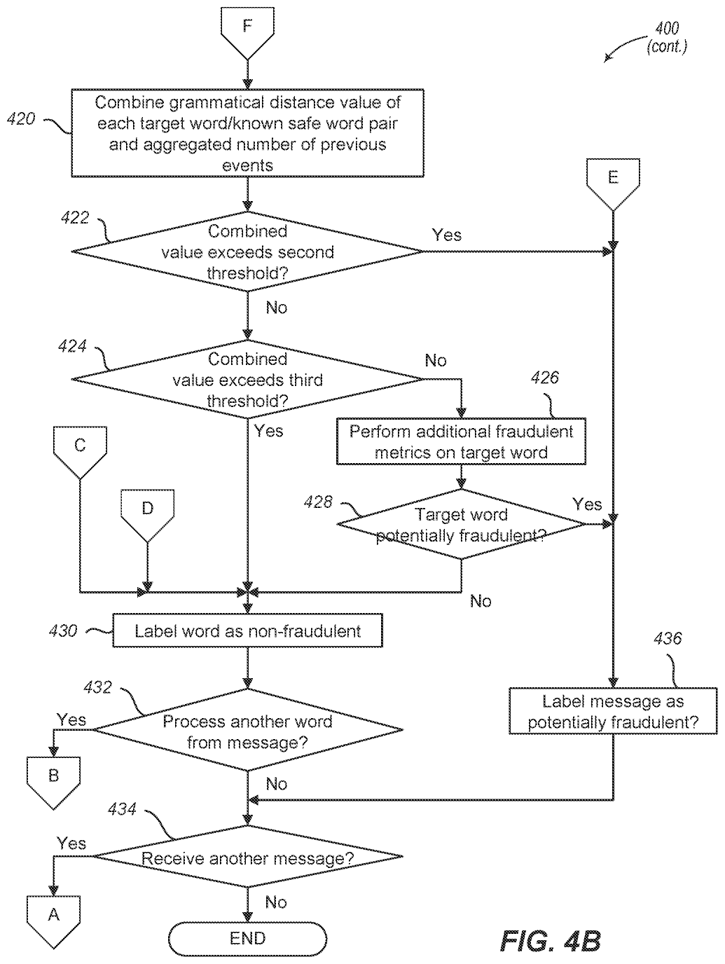

The operation of certain aspects will now be described with respect to FIGS. 3 and 4A-4B. In at least one of various embodiments, processes 300 or 400 described in conjunction with FIGS. 3 and 4A-4B, respectively, may be implemented by or executed via circuitry or on one or more computing devices, such as Message Transport Platform 104 in FIGS. 1 and 2.

FIG. 3 illustrates a logical flow diagram showing an overview process 300 for detecting if a message is possibly fraudulent in accordance with embodiments described herein. Process 300 begins, after a start block, at block 302, where a message is received. In various embodiments, the message is received from a sender in an originating message platform 110 and has a destination of a recipient in a destination messaging platform 112. As mentioned above, the originating messaging platform 110 and the destination messaging platform 112 may be different messaging platforms or they may be the same messaging platform.

The message includes at least one word, where a word is a grouping or string of multiple characters. These characters may be alphanumeric characters, punctuation, emoticons, or other specialty symbols or characters. For ease of discussion, a word may be a linguistic word or a string of characters. In some embodiments, a word may be a portion of a longer string. For example, if the string is a URL, then the URL may be separated into separate words, such as the domain name, etc. Moreover, the domain name itself may be subdivided into additional words using word recognition techniques. In some embodiments, the word may be a sliding window along a string. In other embodiments, the word may be the entire string. In various embodiments, each word is separately extracted and processed, such as described in more detail below in conjunctions with FIGS. 4A and 4B. For simplicity, process 300 generically describes processing one or more words in the received message.

Process 300 proceeds to block 304, where one or more pre-check rules are applied against each word in the message. As mentioned above, the pre-check rules are applied to words to determine if the word is a known safe word, a known fraudulent word, or some other unknown fraudulent potential word. In some embodiments, block 304 may employ functionality or embodiments of the pre-check module 234 in FIG. 2 to apply pre-check rules.

Process 300 continues at decision block 306, where a determination is made whether the pre-check rules are satisfied. As discussed above, decision block 306 may determine if any words in the message matches a known fraudulent word or if any words don't match known safe words. In some embodiments, decision block 306 may employ functionality or embodiments of the pre-check module 234 in FIG. 2 to determine if a pre-check rule is satisfied.

If a word in a message is a known safe word, then that word is removed from further processing. If a word in a message is a known fraudulent word, then process 300 flows to block 320, where the message is labeled as potentially fraudulent without further processing other words in the message. If a word fails to match a known safe word, then process 300 flows to block 308 to further process those target words.

At block 308, one or more trained classifiers are employed to determine the probability that the target words are associated with a potentially fraudulent word or message. In some embodiments, block 308 may employ functionality or embodiments of the candidate creation module 236 in FIG. 2 to determine the fraudulent probability of words.

Process 300 proceeds next to decision block 310, where a determination is made whether the probability of any target word exceeds a first threshold. In various embodiments, the thresholds may be set by a user or administrator such that a word with a fraudulent probability that exceeds the first threshold is likely potentially fraudulent and a word with a fraudulent probability that does not exceed the first threshold is likely a potential safe word. In some embodiments, decision block 310 may employ functionality or embodiments of the candidate creation module 236 in FIG. 2 to determine the fraudulent probability of words exceeds a threshold.

If the probability of a target word exceeds the first threshold, then process 300 flows to block 312 for that word. If the probability of a target word does not exceed the first threshold, then that word is discarded from further processing. If the probabilities of all target words don't exceed the first threshold, then process 300 flows to block 318, where the message is labeled as a non-fraudulent message.

At block 312, a grammatical distance value is determined between each target word/known safe word pair. In various embodiments, the known safe words are brands, company or product names, etc. In some embodiments, block 312 may employ functionality or embodiments of the distance calculation module 238 in FIG. 2 to determine the grammatical distance value of a target word/known safe word pair.

Process 300 continues next at decision block 316, where a determination is made whether the grammatical distance value of a target word/known safe word pair exceeds a second threshold. In some embodiments, decision block 316 may employ functionality or embodiments of the spam decision module 240 in FIG. 2 to determine if a target word is potentially fraudulent based on the grammatical distance value of the target word/known safe word pair for the corresponding target word.

If the distance value of a pair exceeds the second threshold, then the corresponding target word for that pair is identified as potentially fraudulent and process 300 flows to block 320, where the message is labeled as potentially fraudulent. If the distance value of each a pair does not exceed the second threshold, then the process 300 flows to block 318, where the message is labeled as a non-fraudulent message.

If any words in a message match a known fraudulent word at decision block 306 or if the grammatical distance value of a target word/known safe word pair exceeds a threshold at decision block 316, then process 300 flows from decision block 306 or decision block 316, respectively, to block 320. At block 320, the message is labeled as potentially fraudulent and the message is blocked from being forwarded to its destination. After block 320, process 300 terminates or otherwise returns to a calling process to perform other actions.

If the probability of target words in a message do not exceed a potentially fraudulent threshold at decision block 310 or if the grammatical distance value of each target word/known safe word pair does not exceed another threshold at decision block 316, then process 300 flows from decision block 310 or decision block 316, respectively, to block 318. At block 318, the message is labeled as a non-fraudulent message and the message is forwarded to its destination. After block 318, process 300 terminates or otherwise returns to a calling process to perform other actions.

FIGS. 4A and 4B illustrate a logical flow diagram showing one embodiment of a more detailed process 400 for detecting if a message is possibly fraudulent in accordance with embodiments described herein. In various embodiments, process 400 is a more detailed embodiment of process 300 in FIG. 3.

Starting with FIG. 4A, process 400 begins, after a start block, at block 402, where a message is received. In various embodiments, block 402 may employ embodiments of block 302 in FIG. 3 to receive a message from a sender to a recipient or destination device.

Process 400 proceeds to block 404, where a target word is extracted from the message. The word may be a linguistic word identified by spaces or punctuation, or the word may be a string of characters (e.g., multiple linguistic words or random or semi-random string of characters). In various embodiments, each word in the message is extracted and processed, unless a word is identified as being potentially fraudulent, which is illustrated in FIGS. 4A-4B by various decisions and loops.

Process 400 proceeds to block 406, where one or more pre-check rules are employed against the target word. In various embodiments, block 406 may employ embodiments of block 304 in FIG. 3 to employ pre-check rules against the target word.

Process 400 continues at decision block 408, where a determination is made whether the target word matches a known fraudulent word. In various embodiments, the target word is compared to a list of known fraudulent words. If the target word is a known fraudulent word, then process 400 flows to block 436 in FIG. 4B; otherwise, process 400 flows to decision block 410 in FIG. 4A.

At decision block 410, a determination is made whether the target word matches a known safe word. In various embodiments, the target word is compared to a list of known safe words. If the target word is a known safe word, then process 400 flows to block 430 in FIG. 4B; otherwise, process 400 flows to block 412 in FIG. 4A.

At block 412, a probability that the word is associated with a potentially fraudulent word or message is determined. As described above, one or more machine learning mechanisms may be employed to generate probability that the target word is fraudulent. In various embodiments, block 412 may employ embodiments similar to block 308 in FIG. 3 to determine the probability.

Process 400 proceeds next to decision block 414, where a determination is made whether the fraudulent probability for the target word exceeds a first threshold. If the probability exceeds the first threshold, the process 400 flows to block 416; otherwise, process 400 flows to block 430 in FIG. 4B.

At block 416, grammatical distance values are determined for each target word/known safe word pair. In various embodiments, block 416 employs embodiments similar to block 312 in FIG. 3 to determine the grammatical distance value of each target word/known safe word pair.

Process 400 continues next at block 418, where an aggregated number of previous events of the target word are determined. In In some embodiments, block 418 may employ functionality or embodiments of the event aggregator module 2242 in FIG. 2 to collect and determine an aggregated event value for the target word from previously processed messages.

After block 418, process 400 proceeds to block 420 in FIG. 4B, where the grammatical distance value of each target word/known safe word pair is combined with the aggregated number of previous events for the target word.

Process 400 continues at decision block 422, where a determination is made whether the combined value exceeds a second threshold. In various embodiments, the second threshold is set to identify fraudulent words based on the distance values. If the combined value exceeds the second threshold, then process 400 flows to block 436; otherwise, process 400 flows to decision block 424.

At block 424, a determination is made whether the combined value exceeds a third threshold. In various embodiments, the second threshold is set to identify non-fraudulent words based on the distance values. If the combined value exceeds the third threshold, then process 400 flows to block 430; otherwise, process 400 flows to block 426.

At block 426, additional fraudulent metrics are performed on the target word. In various embodiments, these additional fraudulent metrics may include volumetric analysis, sender or destination analysis, etc. After block 426, process 400 proceeds to decision block 428.

At decision block 428, a determination is made whether the target word is potentially fraudulent based on the additional fraudulent metrics on the target word. If the target word is potentially fraudulent, process 400 flows to block 436; otherwise, process 400 flows to block 430.

At block 436, the message is labeled as potentially fraudulent and is blocked from being forwarded to the destination. After block 436, process 400 flows to decision block 434.

If the target word matches a known safe word at decision block 410 in FIG. 4A, or if the fraudulent probability of the target word does not exceeds the first threshold at decision block 414 in FIG. 4A, or if the combined value exceeds the third threshold at decision block 424 in FIG. 4B, or if the target word is potentially fraudulent based on additional metrics at decision block 428 in FIG. 4B, then process 400 flows from those blocks to block 430. At block 430, the target word is labeled as non-fraudulent and is discarded from further processing.

After block 430, process 400 flows to decision block 432, where a determination is made whether to process another word from the message. If another word in the message has not yet been processed, then process 400 loops to block 404 in FIG. 4A to extract another target word from the message; otherwise, process 400 flows to decision block 434 in FIG. 4B.

At decision block 434, a determination is made whether another message is received. If another message is received, process 400 loops to block 402 in FIG. 4A; otherwise, process 400 terminates or otherwise returns to a calling process to perform other actions.

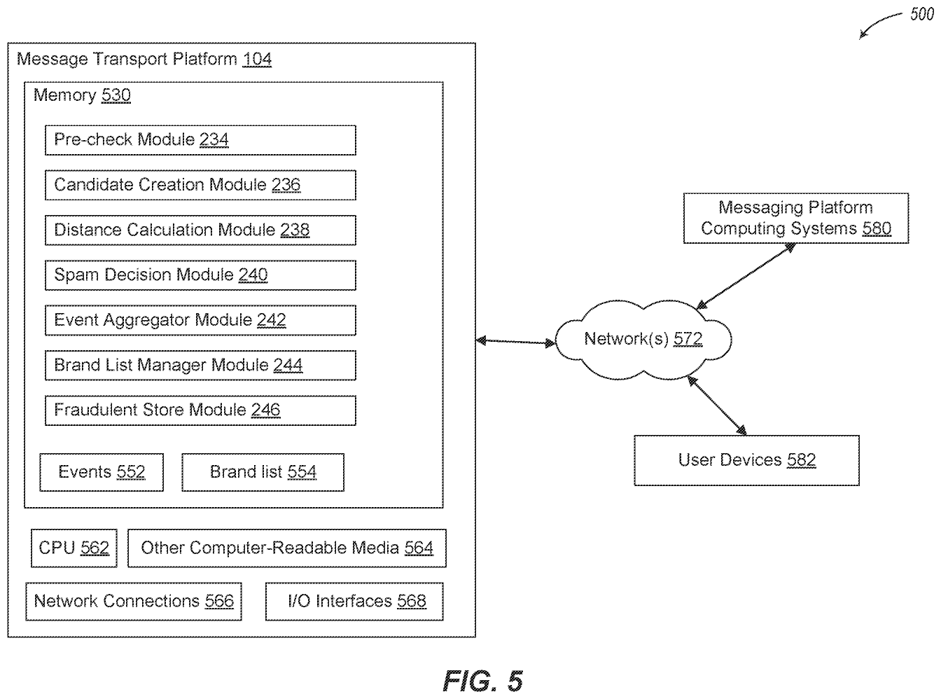

FIG. 5 shows a system diagram that describe various implementations of computing systems for implementing embodiments described herein. System 500 includes a message transport platform 104, one or more messaging platform computing systems 580, and a plurality of user devices 582.

Message transport platform 104 receives messages from user devices 582 via messaging platform computing systems 580. The messages may be transmitted between the separate systems via network 572. The network 572 is configured to couple various computing devices to transmit messages from one or more devices to one or more other devices. For example, network 572 may be the Internet, X.25 networks, or a series of smaller or private connected networks that carry the content. Network 572 may include one or more wired or wireless networks.

One or more special-purpose computing systems may be used to implement message transport platform 104. Accordingly, various embodiments described herein may be implemented in software, hardware, firmware, or in some combination thereof. Message transport platform 104 may include memory 530, one or more central processing units (CPUs) 562, Input/Output (I/O) interfaces 568, other computer-readable media 564, and network connections 566.

Memory 530 may include one or more various types of non-volatile and/or volatile storage technologies. Examples of memory 530 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 530 may be utilized to store information, including computer-readable instructions that are utilized by CPU 562 to perform actions, including embodiments described herein.

Memory 530 may have stored thereon the pre-check module 234, the candidate creation module 236, the distance calculation module 238, the spam decision module 240, the event aggregator module 242, the brand list manager module 244, and the fraudulent store module 246, which are described in more detail above in conjunction with FIG. 2.

Although the pre-check module 234, the candidate creation module 236, the distance calculation module 238, the spam decision module 240, the event aggregator module 242, the brand list manager module 244, and the fraudulent store module 246 are shown as separate modules, embodiments are not so limited. Rather, some module may be combined, some modules may be split into multiple modules, or a single module may be utilized to perform the functionality described herein.

Memory 530 may also store events 552 and brand list 554. The events 552 may be an aggregation or tally of word events occurring during the processing of multiple messages over time. The brand list 554 may include a list of known safe words. In some embodiments, the brand list 554 may also include a list of known fraudulent words. The events 552 or the brand list 554 may be accessed by one or more of the modules to perform the embodiments described herein. The other programs and data (not illustrated0 may also be stored in the memory 530.

I/O interfaces 568 may include one or more input or output interfaces to present content to the viewer or to receive input from the viewer. Examples of such I/O interfaces 568 may include display interfaces, other video interfaces, keyboard, audio interfaces, or the like.

Other computer-readable media 564 may include other types of stationary or removable computer-readable media, such as removable flash drives, external hard drives, or the like.

Network connections 566 are configured to communicate with other computing devices, such as messaging platform computing systems 580 via network 572.

Messaging platform computing systems 580 and user devices 582 may include other computing components, such as a processor, memory, displays, network connections, input out/output interfaces, or the like, but they are not described herein for ease of illustration.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a message having at least one target word intended for a destination;
for each target word in the message:
determining if the target word matches a known fraudulent word or a known safe word;
in response to determining that the target word matches a known fraudulent word, labeling the message as potentially fraudulent; and
in response to determining that the target word does not match a known fraudulent word or a known safe word:
determining a probability that the target word is potentially fraudulent based on context of the target word in the message;
in response to determining that the probability exceeds a first threshold:
determining grammatical distance values between the target word and each known safe word from a list of known safe words for each target word/known safe word pair; and
in response to the grammatical distance value of a target word/known safe word pair exceeding a second threshold, labeling the message as potentially fraudulent;
in response to labeling the message as potentially fraudulent, discarding the message; and
in response to not labeling the message as potentially fraudulent, forwarding the message towards the destination.

2. The method of claim 1, further comprising:
in response to determining that the target word matches a known safe word, labeling the target word as non-fraudulent.

3. The method of claim 1, further comprising:
labeling the target word as non-fraudulent in response to determining that the target word matches a known safe word; and
processing a next target word in the message in response to labeling the target word as non-fraudulent.

4. The method of claim 1, further comprising:
in response to the grammatical distance value of a target word/known safe word pair not exceeding a third threshold, labeling the target word as non-fraudulent.

5. The method of claim 1, further comprising:
labeling the target word as safe in response to the grammatical distance value of a target word/known safe word pair not exceeding a third threshold; and
processing a next target word in the message in response to labeling the target word as non-fraudulent.

6. The method of claim 1, further comprising:
in response to the grammatical distance value of a target word/known safe word pair not exceeding the second threshold but exceeding a third threshold, performing additional fraudulent metrics on the target word.

7. The method of claim 1, further comprising:
determining an aggregated number of previous events associated with the target word in other messages;
generating a combined value for each target word/known safe word pair by combining the grammatical distance values with the aggregated number of previous events for each target word/known safe word pair; and
in response to the combined value for a target word/known safe word pair exceeding the second threshold, labeling the message as potentially fraudulent.

8. The method of claim 7, further comprising:
in response to the combined value for a target word/known safe word pair not exceeding the second threshold but exceeding a third threshold, performing additional fraudulent metrics on the target word.

9. A computing device, comprising:
a memory that stores computer instructions; and
a processor configured to execute the computer instructions to:
receive a message having at least one target word intended for a destination;
for each target word in the message:
determine if the target word matches a known fraudulent word or a known safe word;
label the message as potentially fraudulent in response to determining that the target word matches a known fraudulent word; and
in response to determining that the target word does not match a known fraudulent word or a known safe word:
determine a probability that the target word is potentially fraudulent based on context of the target word in the message; and
in response to determining that the probability exceeds the first threshold:
determine grammatical distance values between the target word and each known safe word from a list of known safe words for each target word/known safe word pair; and
label the message as potentially fraudulent in response to the grammatical distance value of a target word/known safe word pair exceeding a second threshold;
discard the message in response to labeling the message as potentially fraudulent; and
forward the message towards the destination in response to not labeling the message as potentially fraudulent.

10. The computing device of claim 9, wherein the processor is configured to further execute the computer instructions to:
in response to determining that the target word matches a known safe word, label the target word as non-fraudulent.

11. The computing device of claim 9, wherein the processor is configured to further execute the computer instructions to:
label the target word as non-fraudulent in response to determining that the target word matches a known safe word; and
process a next target word in the message in response to labeling the target word as non-fraudulent.

12. The computing device of claim 9, wherein the processor is configured to further execute the computer instructions to:
in response to the grammatical distance value of a target word/known safe word pair not exceeding a third threshold, label the target word as non-fraudulent.

13. The computing device of claim 9, wherein the processor is configured to further execute the computer instructions to:
label the target word as safe in response to the grammatical distance value of a target word/known safe word pair not exceeding a third threshold.
process a next target word in the message in response to labeling the target word as non-fraudulent.

14. The computing device of claim 9, wherein the processor is configured to further execute the computer instructions to:
in response to the grammatical distance value of a target word/known safe word pair not exceeding the second threshold but exceeding a third threshold, perform additional fraudulent metrics on the target word.

15. The computing device of claim 9, wherein the processor is configured to further execute the computer instructions to:
determine an aggregated number of previous events associated with the target word in other messages;
generate a combined value for each target word/known safe word pair by combining the grammatical distance values with the aggregated number of previous events for each target word/known safe word pair; and
in response to the combined value for a target word/known safe word pair exceeding the second threshold, label the message as potentially fraudulent.

16. The computing device of claim 15, wherein the processor is configured to further execute the computer instructions to:
in response to the combined value for a target word/known safe word pair not exceeding the second threshold but exceeding a third threshold, perform additional fraudulent metrics on the target word.

17. A system, comprising:
pre-check circuitry configured to:
receive a message having a target word intended for a destination;
determine if the target word matches a known fraudulent word or a known safe word; and
label the message as potentially fraudulent in response to determining that the target word matches a known fraudulent word;
candidate creation circuitry configured to:
determine a probability that the target word is potentially fraudulent based on context of the target word in the message in response to determining that the target word does not match a known fraudulent word or a known safe word; and
distance calculation circuitry configured to:
determine grammatical distance values between the target word and each known safe word from a list of known safe words for each target word/known safe word pair in response to determining that the probability does exceeds the first threshold; and
spam decision circuitry configured to:
label the message as potentially fraudulent in response to the grammatical distance value of a target word/known safe word pair exceeding a second threshold;
discard the message in response to labeling the message as potentially fraudulent; and
forward the message towards the destination in response to not labeling the message as potentially fraudulent.

18. The system of claim 17, wherein the pre-check circuitry is further configured to:
label the target word as non-fraudulent in response to determining that the target word matches a known safe word; and
process a next target word in the message in response to labeling the target word as non-fraudulent.

19. The system of claim 17, wherein the distance calculation circuitry is further configured to:
label the target word as safe in response to the grammatical distance value of a target word/known safe word pair not exceeding a third threshold; and
process a next target word in the message in response to labeling the target word as non-fraudulent.

20. The system of claim 17, wherein the spam decision circuitry is further configured to:
determine an aggregated number of previous events associated with the target word in other messages;
generate a combined value for each target word/known safe word pair by combining the grammatical distance values with the aggregated number of previous events for each target word/known safe word pair;
label the message as potentially fraudulent in response to the combined value for a target word/known safe word pair exceeding the second threshold; and
perform additional fraudulent metrics on the target word in response to the combined value for a target word/known safe word pair not exceeding the second threshold but exceeding a third threshold.
